(19) United States
(12) Patent Application Publication
(10) Pub. No.: US 2026/0323523 A1
(43) Pub. Date: Oct. 15, 2026

(54) Automatic Reducing of User Equipment Capabilities in Power Saving Mode

(71) Applicant: Apple Inc., Cupertino, CA (US)

(72) Inventors: Junzhen QIN, Beijing (CN); Jishan GAO, Beijing (CN); Lakshmi N KAVURI, San Jose, CA (US); Lijie ZHANG, Beijing (CN); Shangfeng LI, Beijing (CN); Shuang WANG, Beijing (CN); Tao XIE, Beijing (CN); Xiao NIE, Beijing (CN)

(21) Appl. No.: 19/484,549

(22) PCT Filed: May 16, 2023
(86) PCT No.: PCT/CN2023/094481

§ 371 Date: Nov. 14, 2025

(51) Int. Cl. H04W 52/02

(52) U.S. Cl. CPC H04W 52/0251

(57) ABSTRACT

A user equipment (UE) has a full set of baseband processing capabilities when in a normal power mode. The UE transmits, to a base station, a reduced set of baseband processing capabilities for a low power mode, wherein the reduced set of baseband processing capabilities is a smaller subset of the full set of baseband processing capabilities, enters the low power mode and performs operations in the low power mode using the reduced set of baseband processing capabilities.

### TECHNICAL FIELD

This disclosure relates generally to wireless communication systems, in particular to automatic reducing of user equipment capabilities in power saving mode.

### BACKGROUND

Wireless communication systems are rapidly growing in usage. In recent years, wireless devices such as smart phones and tablet computers have become increasingly sophisticated. In addition to supporting telephone calls, many mobile devices (i.e., user equipment devices or UEs) now provide access to the internet, email, text messaging, and navigation using the global positioning system (GPS) and are capable of operating sophisticated applications that utilize these functionalities. A current telecommunications standard moving beyond previous standards is called 5th generation mobile networks or 5th generation wireless systems, referred to as 3GPP NR (otherwise known as 5G-NR or NR-5G for 5G New Radio, also simply referred to as NR). NR proposes a higher capacity for a higher density of mobile broadband users, also supporting device-to-device, ultra-reliable, and massive machine communications, as well as lower latency and lower battery consumption, than LTE standards.

One aspect of wireless communication systems, including NR cellular wireless communications, is with all of the added functionality, battery life is a long-standing issue, with the added features of NR having a direct impact on the user experience by the increased power consumption. At the device level, a “low power mode,” “low battery mode” or “battery saving mode” is an optimization scheme widely adopted in different smart phone operation systems. In this mode, the UE identifies the remaining charge left in the battery, and when the battery level is below a certain threshold, the UE triggers a low power mode causing the UE to perform certain actions on the device to prolong the battery life (or slow down the battery's drain). Currently, UEs in low power mode can prolong battery life by taking various steps. However, in the low power mode, certain baseband operations did not consider new features of NR, which may still cause unexpected power consumption. Thus, improved methods for conserving power in NR systems are needed.

### SUMMARY

Some exemplary embodiments are related to a method for wireless communications performed by a user equipment (UE) having a full set of baseband processing capabilities when in a normal power mode. The method includes transmitting, to a base station, a reduced set of baseband processing capabilities for a low power mode, wherein the reduced set of baseband processing capabilities is a smaller subset of the full set of baseband processing capabilities, entering the low power mode and performing operations in the low power mode using the reduced set of baseband processing capabilities.

Other exemplary embodiments are related to a method for wireless communications performed by a base station. The method includes receiving, from a user equipment (UE), an indication that the UE is entering low power mode, receiving, from the UE, a reduced set of baseband processing capabilities for the low power mode, wherein the reduced set of baseband processing capabilities is a smaller subset of a full set of baseband processing capabilities that the UE has in normal power mode and transmitting configuration information to the UE, wherein the configuration information is based on the reduced set of baseband processing capabilities.

### BRIEF DESCRIPTION OF THE DRAWINGS

FIG. 1 shows an exemplary network arrangement according to various exemplary embodiments.

FIG. 2 shows an exemplary user equipment (UE) according to various exemplary embodiments.

FIG. 3 shows an exemplary base station according to various exemplary embodiments.

FIG. 4 shows an exemplary flow diagram illustrating a method for a UE to indicate to the network that the UE is entering low power mode and to share a reduced set of processing capabilities with the network, according to various exemplary embodiments.

FIG. 5 shows an exemplary flow diagram illustrating a method for a UE to indicate to the network that the UE is quitting low power mode and to share a new set of processing capabilities with the network, according to various exemplary embodiments.

FIG. 6 shows an exemplary flow diagram illustrating a method for a UE to share a reduced set of processing capabilities with the network and to indicate to the network that the UE is entering low power mode, according to various exemplary embodiments.

FIG. 7 shows an exemplary flow diagram illustrating a method for a UE to share a new set of processing capabilities with the network and to indicate to the network that the UE is quitting low power mode, according to various exemplary embodiments.

While features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

The exemplary embodiments may be further understood with reference to the following description and the related appended drawings, wherein like elements are provided with the same reference numerals. The exemplary embodiments relate to a user equipment (UE) reducing its capabilities, and in particular, its baseband processing capabilities while in a low power mode, to provide even more power savings.

The exemplary embodiments are described with regard to a user equipment (UE). However, reference to a UE is merely provided for illustrative purposes. The exemplary embodiments may be utilized with any electronic component that may establish a connection to a network and is configured with the hardware, software, and/or firmware to exchange information and data with the network. Therefore, the UE as described herein is used to represent any appropriate type of electronic component.

The exemplary embodiments are also described with regard to a fifth generation (5G) New Radio (NR) network and a next generation node B (gNB). However, reference to a 5G NR network and a gNB is merely provided for illustrative purposes. The exemplary embodiments may be utilized with any appropriate type of network and base station.

The exemplary embodiments describe operations for a user equipment (UE) to automatically reduce its capabilities, and in particular, its baseband processing capabilities while in a low power mode, in order to provide even more power savings. The UE will send the reduced set of baseband processing capabilities to the network so that the network can configure the UE appropriately using the reduced set of baseband processing capabilities.

Thus, a method for wireless communications is disclosed where a user equipment having a full set of baseband processing capabilities when in a normal power mode (or normal battery mode) transmits, to a base station, a reduced set of baseband processing capabilities for a low power mode. The reduced set of baseband processing capabilities is a smaller subset of the full set of baseband processing capabilities. The UE enters the low power mode and performs operations in the low power mode using the reduced set of baseband processing capabilities. The base station will send configuration information to the UE based on the reduced set of baseband processing capabilities.

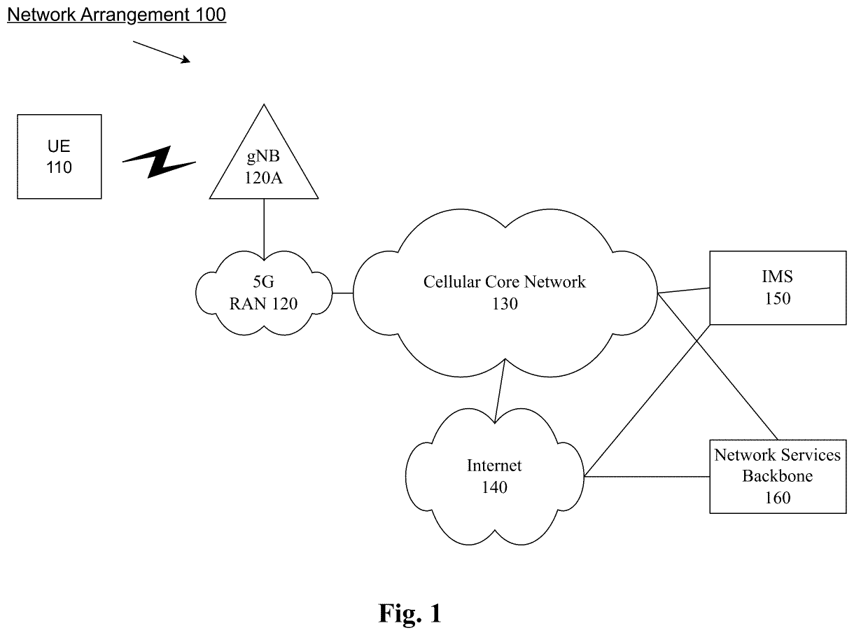

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network arrangement 100, the network with which the UE 110 may wirelessly communicate is a 5G NR radio access network (RAN) 120. However, the UE 110 may also communicate with other types of networks (e.g., sixth generation (6G) RAN, 5G cloud RAN, a next generation RAN (NG-RAN), a long-term evolution (LTE) RAN, a legacy cellular network, a wireless local area network (WLAN), etc.) and the UE 110 may also communicate with networks over a wired connection. With regard to the exemplary embodiments, the UE 110 may establish a connection with the 5G NR RAN 120. Therefore, the UE 110 may have at least a 5G NR chipset to communicate with the 5G NR RAN 120.

The 5G NR RAN 120 may be a portion of a cellular network that may be deployed by a network carrier (e.g., Verizon, AT&T, T-Mobile, etc.). The 5G NR RAN 120 may include base stations or access nodes (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

In the network arrangement 100, the 5G NR PAN 120 deploys a gNB 120A. The gNB 120A may be configured with multiple TRPs. Each TRP may represent one or more components configured to transmit and/or receive a signal. In some embodiments, multiple TRPs may be deployed locally at the gNB 120A. In other embodiments, multiple TRPs may be distributed at different locations and connected to the gNB 120A via a backhaul connection. For example, multiple small cells may be deployed at different locations and connected to the gNB 120A. However, these examples are merely provided for illustrative purposes. Those skilled in the art will understand that TRPs are configured to be adaptable to a wide variety of different conditions and deployment scenarios. Thus, any reference to a TRP being a particular network component or multiple TRPs being deployed in a particular arrangement is merely provided for illustrative purposes. The TRPs described herein may represent any type of network component configured to transmit and/or receive a beam.

Those skilled in the art will understand that any association procedure may be performed for the UE 110 to connect to the 5G NR PAN 120. For example, as discussed above, the 5G NR PAN 120 may be associated with a particular cellular provider where the UE 110 and/or the user thereof has a contract and credential information (e.g., stored on a SIM card). Upon detecting the presence of the 5G NR PAN 120, the UE 110 may transmit the corresponding credential information to associate with the 5G NR PAN 120. More specifically, the UE 110 may associate with a specific base station, e.g., the gNB 120A.

The network arrangement 100 also includes a cellular core network 130, the Internet 140, an IP Multimedia Subsystem (IMS) 150, and a network services backbone 160. The cellular core network 130 may refer to an interconnected set of components that manages the operation and traffic of the cellular network. It may include the evolved packet core (EPC) and/or the 5G core (5GC). The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

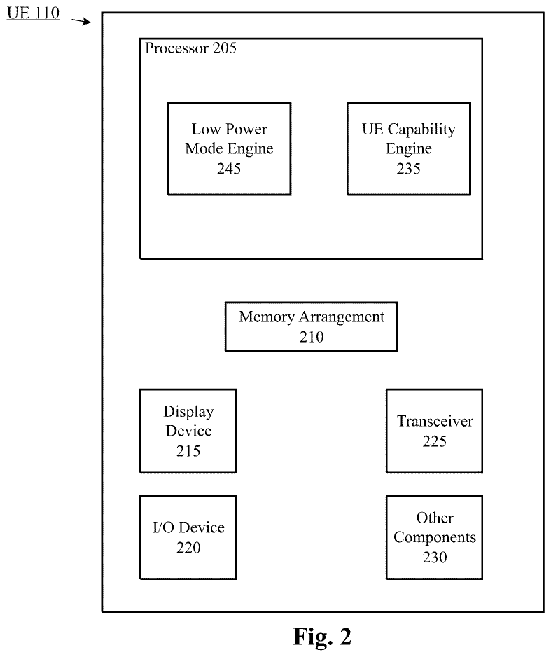

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute a plurality of engines of the UE 110. For example, the engines may include a UE capability engine 235. The UE capability engine 235 may perform various operations related to the capabilities of the UE 110. To provide some general examples, the UE capability engine 235 may perform operations such as, but not limited to, determining the operating capabilities of the UE 110, determining when the capabilities of the UE 110 should change, informing the network of the capabilities of the UE 110, and the like.

In addition, the engines may include a low power mode engine 245. The low power mode engine 235 may perform various operations related to the capabilities of the UE 110 while the UE 110 is in low power mode. To provide some general examples, the low power mode engine 245 may perform operations such as, but not limited to, determining when the UE 110 should enter or quit low power mode, what the operating capabilities of the UE 110 should be in low power mode (reduced set of capabilities) or not in low power mode (a fuller set of capabilities), and operating using the appropriate set of capabilities depending on the mode, and the like.

The above referenced engines 235 and 245 each being an application (e.g., a program) executed by the processor 205 are merely provided for illustrative purposes. The functionality associated with each of the engines 235 and 245 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engine may also be embodied as one application or separate applications. In addition, in some UEs, the functionality described for the processor 205 is split among two or more processors such as a baseband processor and an applications processor. In particular, in some examples, it is the capabilities of the UE 110 typically handled by the baseband processor that may be reduced when the UE 110 is operating in the low power mode. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G NR-RAN 120, an LTE-RAN (not pictured), a legacy RAN (not pictured), a WLAN (not pictured), etc. Accordingly, the transceiver 225 may operate on a variety of different frequencies or channels (e.g., set of consecutive frequencies).

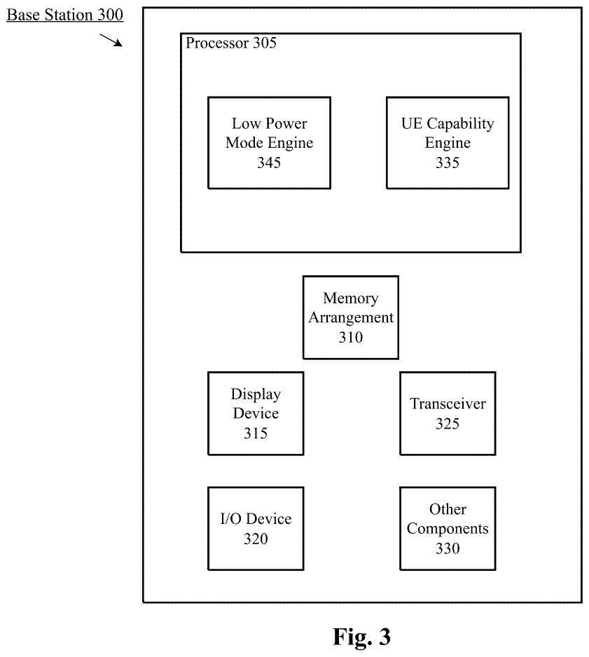

FIG. 3 shows an exemplary base station 300 according to various exemplary embodiments. The base station 300 may represent the gNB 120A or any other type of access node through which the UE 110 may establish a connection and manage network operations.

The base station 300 may include a processor 305, a memory arrangement 310, a display device 315, an input/output (I/O) device 320, a transceiver 325, and other components 330. The other components 330 may include, for example, an audio input device, an audio output device, a battery, a data acquisition device, ports to electrically connect the base station 300 to other electronic devices and/or power sources, TxRUs, transceiver chains, antenna elements, antenna panels, etc.

The processor 305 may be configured to execute a plurality of engines for the base station 300. For example, the engines may include a UE capability engine 335. The UE capability engine 335 may perform various operations for the base station 300 related to the capabilities of the UE 110. To provide some general examples, the UE capability engine 335 may perform operations such as, but not limited to, transmitting a signal to inquire as to the capabilities of the UE 110, trigger the UE 110 to dynamically switch to a different set of capabilities, transmitting configuration information to the UE 110 to perform operations based on the current capabilities of the UE 110, and the like.

In addition, the engines may include a low power mode engine 345. The low power mode engine 345 may perform various operations for the base station when it is communicating with a UE 110 related to the capabilities of the UE 110 while the UE 110 is in low power mode. To provide some general examples, the low power mode engine 345 may perform operations such as, but not limited to, inquiring as to, or receiving signaling indicative of, whether the UE 110 is in low power mode or not; transmitting configuration information to the UE based on whether the UE 110 is low power mode (reduced set of capabilities) or not in low power mode (a fuller set of capabilities); operating using the appropriate set of capabilities depending on the mode of the UE 110, and the like.

The above noted engines 335 and 345 each being an application (e.g., a program) executed by the processor 305 is only exemplary. The functionality associated with the engines 335 and 345 may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.). In particular, in some examples, it is the operations for communicating with the UE 110 that are typically handled by the baseband processor that may be reduced when the UE 110 is operating in the low power mode. The exemplary embodiments may be implemented in any of these or other configurations of a base station.

The memory arrangement 310 may be a hardware component configured to store data related to operations performed by the base station 300. The I/O device 320 may be a hardware component or ports that enable a user to interact with the base station 300. The transceiver 325 may be a hardware component configured to exchange data with the UE 110 and any other UEs in the network arrangement 100. The transceiver 325 may operate on a variety of different frequencies or channels (e.g., set of consecutive frequencies). Therefore, the transceiver 325 may include one or more components to enable the data exchange with the various networks and UEs.

As previously mentioned, wireless communications, such as NR cellular wireless communications, involve lots of processing by both a UE 110 and a network node, such as gNB 120A. The UE 110 currently has a low power mode (also known as “low battery mode” or “battery saving mode”) in which the operating system (OS) of the UE triggers a low power mode causing the UE 110 to perform certain actions on the device to prolong the battery life (or slow down the battery's drain) when the UE 110 recognizes that the battery level is below a certain threshold. For example, UEs in power saving mode may save power by closing applications, preventing device applications from running, lowering the screen brightness of the device, reducing the animation effect, or reducing the network inquiries for some or all applications (e.g., notifications, etc.). However, in the low power mode, unexpected power consumption may still occur, due to the fact that new features of NR were not considered by certain baseband operations. That is, the baseband processor in the UE 110 does not currently do anything different in low power mode. Most of the changes in low power mode are currently performed at the application layer. In the low power mode, the user expects to save more power and does not necessarily expect high throughput. Thus, improved methods for conserving power in NR systems are needed in order to save more power while still maintaining some necessary operations.

As disclosed herein, for a UE in low power mode, such as UE 110, certain baseband features can be disabled by changing (e.g., reducing) the capabilities of the UE when the UE is entering low power mode. Power savings may also be realized by changing the baseband search behavior of the UE 110 while in low power mode in order to save power. In some examples, the capabilities of the UE 110 and the search behavior of the UE 110 may be automatically reduced or changed upon the UE receiving an indication to enter the low power mode. The UE 110 may indicate to the network (such as to gNB 120A) the reduced capabilities of the UE while operating in low power mode, either before the UE 110 enters the low power mode, or upon entering the low power mode. This indication may be via Radio Resource Control (RRC) signaling in one example. Further, in certain situations, when there is an indication that the full capabilities of the UE 110 are necessary, those capabilities can be recovered by the UE 110 quitting power mode. In this case, the UE 110 may indicate to the network (such as to base station 120A) that the UE 110 is again using a more complete set of capabilities UE 110. This indication of a fuller set of capabilities may occur either before the UE 110 quits the low power mode, or upon quitting the low power mode.

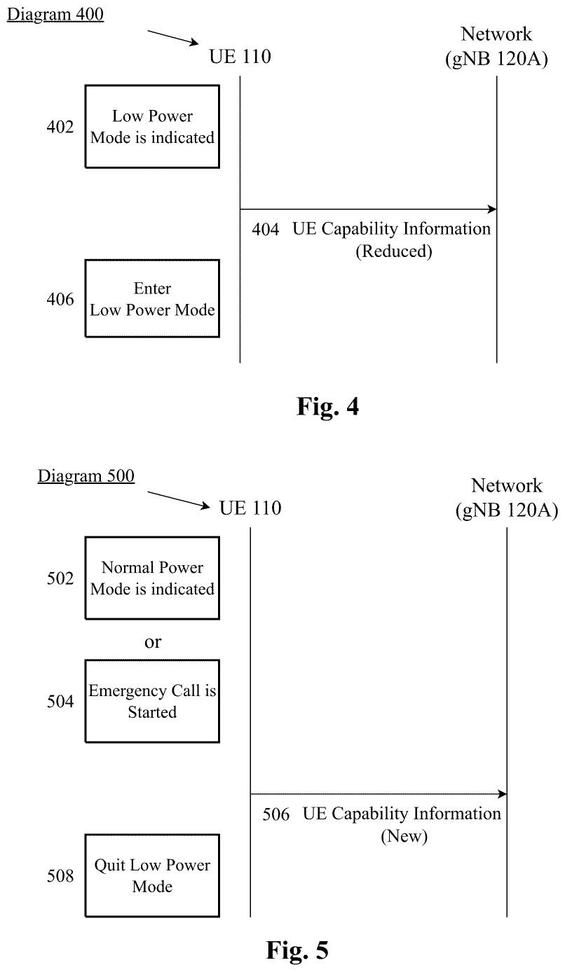

FIG. 4 shows an exemplary flow diagram 400 illustrating a method for a UE, such as UE 110, to indicate to the network that the UE 110 is entering low power mode and to share a reduced set of processing capabilities with the network. In 402, a low power mode is indicated. This may be via a user indication in one example. In another example, the low power mode indication may be a result of an instruction from a network device or an external device. Further, the low power mode may be indicated when the operating system (OS) of the UE 110 identifies the remaining charge left in the battery, and the battery charge level drops below a certain threshold.

Once the low power mode is indicated, the UE 110 will determine a reduced set of processing capabilities for the UE 110 in low power mode and transmit the reduced set of processing capabilities to the network, such as to gNB 120A (404). In one example, a reduced set of processing capabilities for the UE 110 is a smaller subset of a full set of processing capabilities for the UE 110 when it is not in low power mode. In one example, the determination and transmission of the reduced set of processing capabilities in 404 happens automatically upon the indication of low power mode in 402. In another example, not shown in FIG. 4, the UE 110 will first send an indication to the gNB 120A that the UE 110 is going to enter low power mode. Then, in one example, the UE 110 will determine and send the reduced set of processing capabilities to the gNB 120A in a separate message. Further, in a separate example, upon receiving the indication from the UE 110 that a low power mode has been indicated, the gNB 120A may send a query to the UE 110 seeking its processing capabilities, and in response to the query, the UE 110 may transmit the reduced set of processing capabilities to the gNB 120A.

Once the UE 110 has transmitted the reduced set of processing capabilities to the gNB 120A, the UE 110 will enter the low power mode (406). The UE 110 will then operate in low power mode using the reduced set of processing capabilities, as discussed in more detail below.

FIG. 5 shows an exemplary flow diagram 500 illustrating a method for a UE to indicate to the network that the UE is quitting low power mode and to share a new set of processing capabilities with the network. When the UE 110 is operating in low power mode, a need may arise where the UE 110 needs to go back to, or recover, normal power mode (502). This indication of a need to return to normal power mode may be a result of a user indication in one example. In another example, the normal power mode indication may be a result of an instruction from a network device or an external device. Further, the indication of recovery of normal power mode may be indicated when the operating system (OS) of the UE 110 identifies that the current battery charge level has exceeded (went above) a certain threshold. In another example, the indication of a need to recover normal power mode may be that an emergency telephone call (504) is initiated.

Once the indication of a return to normal power mode occurs, the UE 110 will determine a new set of processing capabilities for the UE 110 in normal power mode and transmit the new set of processing capabilities to the network, such as to gNB 120A (506). In one example, the new set of processing capabilities for the UE 110 may be the full set of processing capabilities for the UE 110. In another example, the new set of processing capabilities may be larger than the reduced set of processing capabilities but still less than the full set of processing capabilities. In one example, the determination and transmission of the new set of processing capabilities in 506 happens automatically upon the indication of a need to return to normal power mode in 502. In another example, not shown in FIG. 5, the UE 110 will first send an indication to the gNB 120A that the UE 110 is going to quit low power mode. Then, in one example, the UE 110 will determine and send the new set of processing capabilities to the gNB 120A in a separate message. Further, in a separate example, upon receiving the indication from the UE 110 that the UE 110 is going to quit low power mode, the gNB 120A may send a query to the UE 110 seeking its new processing capabilities, and in response to the query, the UE 110 may transmit the new set of processing capabilities to the gNB 120A.

Once the UE 110 has transmitted the new set of processing capabilities to the gNB 120A, the UE 110 will quit the low power mode (508). The UE 110 will then operate in normal power mode using the new set of processing capabilities, as discussed in more detail below.

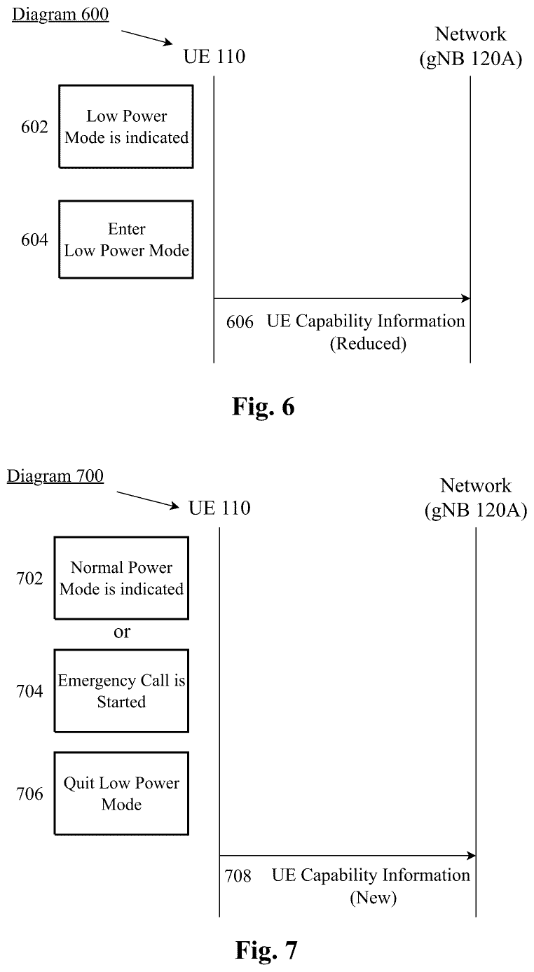

FIG. 6 shows an exemplary flow diagram 600 illustrating a method for a UE to share a reduced set of processing capabilities with the network and to indicate to the network that the UE is entering low power mode. The flow diagram for FIG. 6 is similar to that in FIG. 4, except that in FIG. 6, the UE 110 does not transmit its reduced set of processing capabilities to the network until the UE 110 has already entered the low power mode.

Thus, in FIG. 6, a low power mode is indicated (602). The indication that low power mode is to be entered may be via any of ways discussed above with respect to FIG. 4. The UE 110 then enters low power mode (604). Upon entering low power mode, the UE 110 will determine a reduced set of processing capabilities for the UE 110 in low power mode and transmit the reduced set of processing capabilities to the network, such as to gNB 120A (606). In one example, a reduced set of processing capabilities for the UE 110 is a smaller subset of a full set of processing capabilities for the UE 110 when it is not in low power mode. In one example, the determination and transmission of the reduced set of processing capabilities in 404 happens automatically upon the UE entering low power mode in 604. In another example, not shown in FIG. 6, the UE 110 will first send an indication to the gNB 120A that the UE 110 has entered low power mode. Then, in one example, the UE 110 will determine and send the reduced set of processing capabilities to the gNB 120A in a separate message. Further, in a separate example, upon receiving the indication from the UE 110 that a low power mode has been entered, the gNB 120A may send a query to the UE 110 seeking its processing capabilities, and in response to the query, the UE 110 may transmit the reduced set of processing capabilities to the gNB 120A. Once the UE 110 has transmitted the reduced set of processing capabilities to the gNB 120A, the UE 110 will then operate in low power mode using the reduced set of processing capabilities, as discussed in more detail below.

FIG. 7 shows an exemplary flow diagram 700 illustrating a method for a UE to share a new set of processing capabilities with the network and to indicate to the network that the UE is quitting low power mode. The flow diagram for FIG. 7 is similar to that in FIG. 5, except that in FIG. 7, the UE 110 has quit the low power mode upon the indication of a need to return to normal power mode and does not transmit its new set of processing capabilities to the network until the UE 110 has already quit the low power mode.

Thus, in FIG. 7, the UE 110 is operating in low power mode, and there is an indication of a need to recover normal power mode (702). This indication of a need to return to normal power mode may be any of the methods discussed above with respect to FIG. 5. For example, the indication of a need to recover normal power mode may be that an emergency telephone call (704) is initiated.

In the method of FIG. 7, once the indication of a return to normal power mode occurs, the UE 110 will quit low power mode (706). Upon quitting low power mode, the UTE 110 will determine a new set of processing capabilities for the UE 110 in normal power mode and transmit the new set of processing capabilities to the network, such as to gNB 120A (708). In one example, the new set of processing capabilities for the UE 110 may be the full set of processing capabilities for the UE 110. In another example, the new set of processing capabilities may be larger than the reduced set of processing capabilities but still less than the full set of processing capabilities. In one example, the determination and transmission of the new set of processing capabilities in 708 happens automatically upon the UE 110 quitting low power mode in 706.

In another example, not shown in FIG. 7, the UE 110 will first send an indication to the gNB 120A that the UE 110 has quit low power mode and returned to normal power mode. Then, in one example, the UE 110 will determine and send the new set of processing capabilities to the gNB 120A in a separate message. Further, in a separate example, upon receiving the indication from the UE 110 that the UE 110 is going to quit low power mode, the gNB 120A may send a query to the UE 110 seeking its new processing capabilities, and in response to the query, the UE 110 may transmit the new set of processing capabilities to the gNB 120A.

Once the UE 110 has quit low power mode and transmitted the new set of processing capabilities to the gNB 120A, the UE 110 will operate in normal power mode using the new set of processing capabilities, as discussed in more detail below.

As mentioned above, the reduced set of processing capabilities for the UE in low power mode can be a smaller subset of the full set of processing capabilities for the UE 110. In particular, the reduced set of processing capabilities are mostly, if not all, baseband operations (i.e., not application layer capabilities). Currently, in the typical low power mode, a UE may reduce power consumption through various methods, but these techniques occur mainly, if not completely, at the application layer. Thus, in typical low power mode, the UE still has to perform certain operations that consume power. Thus, in the current disclosure, the UE will determine and transmit to the network a reduced set of processing capabilities on the baseband side, where the UE can realize additional power savings while in low power mode in situations where high throughput and performance is not expected.

In order to reduce the processing capabilities on the baseband side, some features of the baseband processing can be disabled by changing the processing capabilities and indicating the reduced processing capabilities to the network. For example, some of the operations that consume power even in typical low power mode are multiple-input, multiple-output (MIMO) communications, particularly uplink MIMO communications. Enhanced NR frequency range 2 (FR2-1) UEs may typically support up to four uplink (UL) MIMO layers with dual transmission configuration indication (TCI) with different quasi-co-located (QCL) typeD signals on a single component carrier. The UL MIMO layers may consume power even if the UE is in a low power mode.

Thus, in the present disclosure, for low power mode, the UE 110 may transmit an indication to the network (gNB 120A) that the UE 110 has disabled (closed) the UL MIMO layers and instead has entered a mode where the UE 110 will use only single input single output (SISO) for UL. This may be accomplished in one example by setting MIMO-LayersUL=1. In one example, the UE 110 may still be capable of two transceivers (TXs) for reception (2T4R), which can keep downlink (DL) performance acceptable.

Accordingly, in the present disclosure, the reduced set of capabilities sent by the UE 110 (see 404 in FIG. 4 above, or 606 in FIG. 6) will indicate to the network that the UE 110 is only capable of using SISO for UL while in the low power mode. By reporting this reduced capability to the network (GB 120A), it may be ensured that the gNB 120A will schedule accordingly to avoid any issues of UL quality. That is, the gNB 120A will only send configuration information to the UE 110 that is consistent with the reduced set of capabilities (i.e., SISO) sent by the UE 110 to the network. Testing has indicated that the power usage of SISO compared to MIMO while in low power mode may result in a power savings of well over 20% and as much as 27% while still maintaining acceptable throughput.

Another area where power is consumed by the UE even in typical low power mode is due to the fact that the baseband operations may include four antennas designed for DL performance (4RX), and all four antennas may be used even while in low power mode. However, in low power mode, for a basic service call, or other situations where lower throughput is sufficient, one antenna (1RX) or two antennas (2RX) may be sufficient.

Thus, in the present disclosure, for low power mode, the UE 110 may transmit an indication to the network (gNB 120A) that the UE 110 has reduced its capability by reducing the number of DL MIMO layers for lower battery mode from four to one or two. That is, the UE 110 will force the DL MIMO layers to 1RX/2RX. In one example, the UE will only force to 1RX/2RX where there are good channel conditions in idle and connected states. This may be accomplished in one example by setting MaxMIMO-LayerPreference-r16 accordingly as seen below.

| MaxMIMO-LayerPreference-r16 ::= | SEQUENCE{ |
|---|---|
| reducedMAXMIMO-LayersFR1-r16 | SEQUENCE { |
| reducedMIMO-LayersFR1-DL-r16 | INTEGER (1..8), |
| reducedMIMO-LayersFR1-UL-r16 | INTEGER (1..4), |
| } OPTIONAL, | |
| reducedMAXMIMO-LayersFR2-r16 | SEQUENCE { |

Accordingly, in the present disclosure, the reduced set of capabilities sent by the UE 110 (see 404 in FIG. 4 above, or 606 in FIG. 6) will indicate to the network that the UE 110 is only capable of using 1RX or 2RX for DL MIMO while in the low power mode. By reporting this reduced capability to the network (GB 120A), it may be ensured that the gNB 120A will schedule accordingly to avoid any issues of DL quality. That is, the gNB 120A will only send configuration information to the UE 110 that is consistent with the reduced set of capabilities (i.e., 1RX or 2RX) sent by the UE 110 to the network. Testing has indicated that the power usage of 2RX versus 4RX while in low power mode may result in a power savings of well over 25% while still maintaining acceptable throughput. Using 1RX can save even more power than 2RX, with at least 35% power savings.

Another area where power is consumed by the UE even in typical low power mode is due to UL/DL carrier aggregation (CA). Currently, even in lower power mode, the UE 110 may employ CA schemes, which may result in increased power consumption. Thus, in the current disclosure, the UE can disable CA by changing its reported capabilities. That is, the UE 110, for low power mode, may transmit an indication to the network (gNB 120A) that the UE 110 has reduced its capability by disabling CA. That is, the UE 110 will transmit to the network that it is only supporting a single carrier while in low power mode.

Accordingly, in the present disclosure, the reduced set of capabilities sent by the UE 110 (see 404 in FIG. 4 above, or 606 in FIG. 6) will indicate to the network that the UE 110 is only supporting a single carrier (1 CA) while in the low power mode. By reporting this reduced capability to the network (GB 120A), it may be ensured that the gNB 120A will schedule accordingly to avoid any issues of UL quality. That is, the gNB 120A will only send configuration information to the UE 110 that is consistent with the reduced set of capabilities (i.e., a single carrier) sent by the UE 110 to the network. So, for example, the network will not send any configuration to the UE 110 that requires 2CA or higher. Testing has indicated that the power usage of a single carrier scheme versus LTE 5CA DL while in low power mode may result in a power savings of 65% while still maintaining acceptable throughput. Even a 1 CA as compared to a SA 2CA DL scheme can result in a 48% power savings.

The UE can also conserve additional power while in the low power mode by implementing internal changes to the UE 110. For example, changes can be made to the baseband search behavior of the UE 110 to save additional power. In one example, when the UE is in low power mode, and the UE 110 is out of service (OOS), the UE 110 may be searching for a suitable cell. Currently, the search interval for OOS stage 1 is ten (10) seconds, and OOS stage 2 is (60) seconds. That is, if the UE 110 does not find a suitable cell within the ten seconds (stage 1) or the sixty seconds (stage 2), the UE 110 will start a search for another cell. This uses additional power.

In the present disclosure, the UE can conserve power by doing the search for a suitable cell less often. That is, the UE 110 can increase the search interval for OOS searches to be longer in time. For example, the search interval can be increased to a predetermined threshold value longer than the current ten seconds for OOS stage 1 and longer than the current sixty seconds for OOS stage. The net result is that less OOS searching will take place, which may save additional power. This change in baseband search behavior is internal to the UE and thus not need be communicated to the network, although it could be in some examples. In the situation in FIGS. 5 and 7 where there is an indication to quit low power mode, the legacy search parameters can be reloaded for use by the UE 110 once the UE 110 quits low power mode.

Another change that can be made to the baseband operations of the UE 110 to save additional power is to change the time for local release. Currently, if the UE 110 is in a connected state and transfers data, the UE 110 stays connected to the network for a certain amount of time. The UE will stay connected unless there is no data transfer for the predetermined amount of time or if the network does not send a release message to the UE 110. If the network does not transfer data or send a release message to the UE 110, the UE 110 will wait a certain amount of time and then do a local release. In one example, the current amount of time for this local release is approximately thirty-seven (37) seconds. In the current disclosure, in order to save additional power while the UE 110 is in low power mode, the UE 110 can reduce the time for the local release to a lesser amount of time. In one example, the local release timer may be reduced to approximately ten (10) seconds. In the situation in FIGS. 5 and 7 where there is an indication to quit low power mode, the legacy local release times can be reloaded for use by the UE 110 once the UE 110 quits low power mode.

### EXAMPLES

In a first example, a method for wireless communications, the method comprising: at a user equipment (UE) having a full set of baseband processing capabilities when in a normal power mode: transmitting, to a base station, a reduced set of baseband processing capabilities for a low power mode, wherein the reduced set of baseband processing capabilities is a smaller subset of the full set of baseband processing capabilities, entering the low power mode and performing operations in the low power mode using the reduced set of baseband processing capabilities.

In a second example, the method of the first example, wherein the transmitting the reduced set of baseband processing capabilities occurs prior to the UE entering the low power mode.

In a third example, the method of the second example, wherein the UE entering the low power mode occurs prior to the transmitting the reduced set of baseband processing capabilities.

In a fourth example, the method of the first example, further comprising receiving an indication to enter the low power mode prior to either of the transmitting of the reduced set of baseband processing capabilities or the entering the low power mode.

In a fifth example, the method of the fourth example, wherein the transmitting of the reduced set of baseband of processing capabilities occurs automatically in response to the receiving of the indication to enter the low power mode.

In a sixth example, the method of the first example, further comprising transmitting an indication to the base station that the UE intends to enter low power mode.

In a seventh example, the method of the sixth example, wherein the transmitting the indication occurs prior to the transmitting of the reduced set of baseband processing capabilities.

In an eighth example, the method of the sixth example, further comprising receiving a query from the base station inquiring about the baseband processing capabilities of the UE in the low power mode, wherein the transmitting the reduced set of baseband processing capabilities occurs in response to the receiving of the query from the base station.

In a ninth example, the method of the first example, further comprising determining, at the UE, the reduced set of baseband processing capabilities.

In a tenth example, the method of the first example, further comprising receiving, after the UE has entered the low power mode, an indication of a need to recover normal power mode, transmitting, to the base station, a new set of baseband processing capabilities, quitting the low power mode and performing operations in the normal power mode using the new set of baseband processing operations.

In an eleventh example, the method of the tenth example, wherein the new set of baseband processing capabilities is the full set of baseband processing capabilities.

In a twelfth example, the method of the tenth example, wherein the transmitting of the new set of baseband processing capabilities occurs prior to quitting the low power mode.

In a thirteenth example, the method of the tenth example, wherein the transmitting of the new set of baseband processing capabilities occurs after quitting the low power mode.

In a fourteenth example, the method of the tenth example, wherein the transmitting of the new set of baseband processing capabilities occurs automatically upon receiving the indication of the need to recover normal power mode.

In a fifteenth example, the method of the first example, wherein the transmitting the reduced set of baseband processing capabilities comprises transmitting an indication that the UE supports only single input, single output (SISO) for uplink communications and the UE does not support multiple input, multiple output (MIMO) for uplink communications.

In a sixteenth example, the method of the ninth example, wherein the determining the reduced set of baseband processing capabilities comprises disabling multiple input, multiple output (MIMO) for uplink communications and enabling only single input, single output (SISO) for uplink communications.

In a seventeenth example, the method of the first example, wherein the transmitting the reduced set of baseband processing capabilities comprises transmitting an indication that the UE supports only one or two receive antennas (1RX or 2RX) for downlink multiple input, multiple output (MIMO) communications and the UE does not support four receive antennas (4RX) for downlink MIMO communications.

In an eighteenth example, the method of the ninth example, wherein the determining the reduced set of baseband processing capabilities comprises disabling support for four receive antennas (4RX) for downlink MIMO communications and enabling supporting only a single receive antenna (1RX) or two receive antennas (2RX) for downlink MIMO communications.

In a nineteenth example, the method of the first example, wherein the transmitting the reduced set of baseband processing capabilities comprises transmitting an indication that the UE supports only a single carrier for uplink and downlink communications and the UE does not support multiple carriers or carrier aggregation (CA) for uplink and downlink communications.

In a twentieth example, the method of the ninth example, wherein the determining the reduced set of baseband processing capabilities comprises disabling carrier aggregation for uplink and downlink communications and enabling supporting only a single carrier for uplink and downlink communications.

In a twenty first example, the method of the first example, further comprising increasing a search interval for the UE to use when performing out of service (OOS) searches for suitable cells.

In a twenty second example, the method of the first example, further comprising reducing an amount of time for the UE to wait before performing a local release when the UE has not received a transfer of data or a release message from the base station.

In a twenty third example, the method of the first example, further comprising receiving configuration information from the base station, wherein the configuration information is based on the reduced set of baseband processing capabilities.

In a twenty fourth example, a processor configured to perform any of the methods of the first through twenty third examples.

In a twenty fifth example, a user equipment (UE) comprising a transceiver configured to communicate with a network and a processor communicatively coupled to the transceiver and configured to perform any of the methods of the first through twenty third examples.

In a twenty sixth example, a method for wireless communications, the method comprising, at a base station, receiving, from a user equipment (UE), an indication that the UE is entering low power mode, receiving, from the UE, a reduced set of baseband processing capabilities for the low power mode, wherein the reduced set of baseband processing capabilities is a smaller subset of a full set of baseband processing capabilities that the UE has in normal power mode and transmitting configuration information to the UE, wherein the configuration information is based on the reduced set of baseband processing capabilities.

In a twenty seventh example, the method of the twenty sixth example, wherein the receiving of the indication and the receiving of the reduced set of baseband processing capabilities are in a single message from the UE.

In a twenty eighth example, the method of the twenty sixth example, wherein transmitting the configuration information comprises sending only information for UE configurations supported by the reduced set of baseband processing capabilities.

In a twenty ninth example, the method of the twenty sixth example, further comprising transmitting, after the receiving of the indication and prior to the receiving of the reduced set of baseband processing capabilities, a query to the UE inquiring about the baseband processing capabilities of the UE in the low power mode.

In a thirtieth example, the method of the twenty sixth example, further comprising receiving, from the UE, an indication that the UE is quitting low power mode, receiving, from the UE, a new set of baseband processing capabilities to be used after the UE has quit the low power mode and transmitting new configuration information to the UE, wherein the new configuration information is based on the new set of baseband processing capabilities.

In a thirty first example, the method of the thirtieth example, wherein the new set of baseband processing capabilities is the full set of baseband processing capabilities that the UE has in the normal power mode.

In a thirty second example, the method of the thirtieth example, wherein the receiving of the indication that the UE is quitting low power mode and the receiving of the new set of baseband processing capabilities are in a single message from the UE.

In a thirty third example, the method of the thirtieth example, further comprising transmitting, after the receiving of the indication that the UE is quitting low power mode and prior to the receiving of the new set of baseband processing capabilities, a query to the UE inquiring about the baseband processing capabilities of the UE in normal power mode.

In a thirty fourth example, a processor configured to perform any of the methods of the twenty sixth through thirty third examples.

In a thirty fifth example, a base station comprising a transceiver configured to communicate with a user equipment (UE) and a processor communicatively coupled to the transceiver and configured to perform any of the methods of the twenty sixth through thirty third examples.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments described above may be embodied as a program containing lines of code stored on a non-transitory computer readable storage medium that, when compiled, may be executed on a processor or microprocessor.

In some embodiments, a non-transitory computer-readable memory medium (e.g., a non-transitory memory element) may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) may be configured to include a processor (or a set of processors) and a memory medium (or memory element), where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Embodiments of the present invention may be realized in any of various forms. For example, in some embodiments, the present invention may be realized as a computer-implemented method, a computer-readable memory medium, or a computer system. In other embodiments, the present invention may be realized using one or more custom-designed hardware devices such as ASICs. In other embodiments, the present invention may be realized using one or more programmable hardware elements such as FPGAs.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. A method for wireless communications, the method comprising:
at a user equipment (UE) having a full set of baseband processing capabilities when in a normal power mode:
transmitting, to a base station, a reduced set of baseband processing capabilities for a low power mode, wherein the reduced set of baseband processing capabilities is a smaller subset of the full set of baseband processing capabilities;
entering the low power mode; and
performing operations in the low power mode using the reduced set of baseband processing capabilities.

2. The method of claim 1, wherein the transmitting the reduced set of baseband processing capabilities occurs prior to the UE entering the low power mode.

3. The method of claim 2, wherein the UE entering the low power mode occurs prior to the transmitting the reduced set of baseband processing capabilities.

4. The method of claim 1, further comprising receiving an indication to enter the low power mode prior to either of the transmitting of the reduced set of baseband processing capabilities or the entering the low power mode.

5. The method of claim 4, wherein the transmitting of the reduced set of baseband of processing capabilities occurs automatically in response to the receiving of the indication to enter the low power mode.

6. The method of claim 1, further comprising transmitting an indication to the base station that the UE intends to enter low power mode.

7. The method of claim 6, wherein the transmitting the indication occurs prior to the transmitting of the reduced set of baseband processing capabilities.

8. The method of claim 6, further comprising receiving a query from the base station inquiring about the baseband processing capabilities of the UE in the low power mode, wherein the transmitting the reduced set of baseband processing capabilities occurs in response to the receiving of the query from the base station.

9. The method of claim 1, further comprising determining, at the UE, the reduced set of baseband processing capabilities.

10. The method of claim 1, further comprising:
receiving, after the UE has entered the low power mode, an indication of a need to recover normal power mode;
transmitting, to the base station, a new set of baseband processing capabilities;
quitting the low power mode; and
performing operations in the normal power mode using the new set of baseband processing operations.

11. The method of claim 10, wherein the new set of baseband processing capabilities is the full set of baseband processing capabilities.

12. The method of claim 10, wherein the transmitting of the new set of baseband processing capabilities occurs prior to quitting the low power mode.

13. The method of claim 10, wherein the transmitting of the new set of baseband processing capabilities occurs after quitting the low power mode.

14. The method of claim 10, wherein the transmitting of the new set of baseband processing capabilities occurs automatically upon receiving the indication of the need to recover normal power mode.

15. The method of claim 1, wherein the transmitting the reduced set of baseband processing capabilities comprises transmitting an indication that the UE supports only single input, single output (SISO) for uplink communications and the UE does not support multiple input, multiple output (MIMO) for uplink communications.

16. (canceled)

17. The method of claim 1, wherein the transmitting the reduced set of baseband processing capabilities comprises transmitting an indication that the UE supports only one or two receive antennas (1RX or 2RX) for downlink multiple input, multiple output (MIMO) communications and the UE does not support four receive antennas (4RX) for downlink MIMO communications.

18. (canceled)

19. The method of claim 1, wherein the transmitting the reduced set of baseband processing capabilities comprises transmitting an indication that the UE supports only a single carrier for uplink and downlink communications and the UE does not support multiple carriers or carrier aggregation (CA) for uplink and downlink communications.

20. (canceled)

21. The method of claim 1, further comprising increasing a search interval for the UE to use when performing out of service (OOS) searches for suitable cells.

22. The method of claim 1, further comprising reducing an amount of time for the UE to wait before performing a local release when the UE has not received a transfer of data or a release message from the base station.

23. The method of claim 1, further comprising receiving configuration information from the base station, wherein the configuration information is based on the reduced set of baseband processing capabilities.
